(19) United States
(12) Patent Application Publication
(10) Pub. No.: US 2024/0417492 A1
(43) Pub. Date: Dec. 19, 2024

(54) METHODS OF MAKING BIMODAL POLYETHYLENES

(71) Applicant: UNIVATION TECHNOLOGIES, LLC, Houston, TX (US)

(72) Inventors: Bruce J. Savatsky, Kingwood, TX (US); Timothy R. Lynn, Glen Gardner, NJ (US)

(73) Assignee: Univation Technologies, LLC, Houston, TX (US)

(21) Appl. No.: 18/704,608

(22) PCT Filed: Oct. 25, 2022
(86) PCT No.: PCT/US2022/047645

§ 371 Date: Apr. 25, 2024

Related U.S. Application Data
(60) Provisional application No. 63/271,870, filed on Oct. 26, 2021.

(51) Int. Cl. C08F 2/00; C08F 2/34; C08F 4/76; C08F 210/16

(52) U.S. Cl. CPC C08F 2/001; C08F 2/34; C08F 4/76; C08F 210/16; C08F 2400/02

(57) ABSTRACT

Embodiments are directed towards methods of making binodal polyethylenes, wherein the methods include a plurality of cycles of ratio adjustments.

### FIELD OF DISCLOSURE

Embodiments of the present disclosure are directed towards methods of making bimodal polyethylenes.

### BACKGROUND

Polymers may be utilized for a number of products including films, among others. Polymers can be formed by reacting one or more types of monomer in a polymerization reaction. The different polymerization processes and different reaction components are utilized to make polymers having varying properties. There exists a continuing need for new bimodal polyethylenes and new methods of making bimodal polyethylenes.

### SUMMARY

The present disclosure provides methods of making bimodal polyethylenes, the method comprising: feeding a bimodal catalyst system and a trim solution to a single reactor to establish an average steady-state trim/catalyst ratio, wherein the reactor has an average steady-state reactor residence time; feeding ethylene and 1-hexene to the reactor to establish an average steady-state 1-hexene/ethylene ratio; and performing a plurality of cycles of ratio adjustment, wherein each cycle of ratio adjustment comprises: increasing the average steady-state trim/catalyst ratio to a relative maximum trim/catalyst ratio over a time interval that is from 5% to 15% of the average steady-state reactor residence time, while concurrently decreasing the average steady-state 1-hexene/ethylene ratio to a relative minimum 1-hexene/ethylene ratio; decreasing the relative maximum trim/catalyst ratio to a relative minimum trim/catalyst ratio over a time interval that is from 10% to 30% of the average steady-state reactor residence time, while concurrently increasing the relative minimum 1-hexene/ethylene ratio to a relative maximum 1-hexene/ethylene ratio; and increasing the relative minimum trim/catalyst ratio to the average steady-state trim/catalyst ratio over a time interval that is from 5% to 15% of the average steady-state reactor residence time, while concurrently decreasing the relative maximum 1-hexene/ethylene ratio to the average steady-state1-hexene/ethylene ratio.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a plot of trim/catalyst ratios and 1-hexene/ethylene ratios in accordance with a number of embodiments of the present disclosure.

FIG. 2 is a Gel Permeation Chromatogram (GPC) of bimodal polyethylenes made in accordance with a number of embodiments of the present disclosure.

### DETAILED DESCRIPTION

Methods of making bimodal polyethylenes are disclosed herein. The methods discussed herein include a plurality of cycles of ratio adjustments. As used herein, a “cycle of ratio adjustments” refers to a first process ratio being adjusted from an average steady-state value, e.g., an average steady-state value as known regarding continuously stirred tank reactors, to a relative maximum value and then to a relative minimum value prior to returning to the average steady-state value for the first process ratio, and a second process ratio being adjusted from an average steady-state value to a relative minimum value and then to a relative maximum value prior to returning to the average steady-state value for the second process ratio.

One or more embodiments provide that the first process ratio being adjusted is initially increased from an average steady-state value to a relative maximum value, and that the second process ratio being adjusted is concurrently initially decreased from a steady-state value to a relative minimum value. As discussed further herein, the methods including a plurality of cycles of ratio adjustments can provide an improved, e.g., increased, distribution of comonomer across a high molecular weight portion of a bimodal distribution including the high molecular weight portion and a low molecular weight portion. The increased distribution of comonomer across the high molecular weight portion of a bimodal distribution is desirable for a number of applications and can reduce crack formation of products made from the bimodal polyethene, as compared to products made from other polymers.

A first process ratio that can be adjusted is a trim to catalyst ratio, also referred to as a trim/catalyst ratio. Embodiments of the present disclosure provide that bimodal polyethylenes are made with a bimodal catalyst system and a trim solution. Embodiments provide that the bimodal catalyst system includes a high molecular weight (HMW) component and a low molecular weight (LMW) component, and that the trim solution includes the LMW component. As such, on a molar basis, the trim/catalyst ratio refers to total moles of HMW component to total moles of LMW component fed to the polymerization reactor via the bimodal catalyst system and the trim solution.

As mentioned for a cycle of ratio adjustments, the first process ratio being adjusted, i.e., the trim/catalyst ratio, is adjusted from an average steady-state value to a relative maximum value and then to a relative minimum value prior to returning to the average steady-state value for the first process ratio.

Embodiments of the present disclosure provide that the relative maximum trim/catalyst ratio is 105% to 300% of the average steady-state trim/catalyst ratio on a molar basis. All individual values and subranges from 105% to 300% of the average steady-state trim/catalyst ratio are included; for example, for the relative maximum trim/catalyst ratio can be from a lower limit of 105%, 110%, or 115% to an upper limit of 300%, 250%, or 200% of the average steady-state trim/catalyst ratio on a molar basis.

Embodiments of the present disclosure provide that the relative minimum trim/catalyst ratio is 20% to 95% of the average steady-state trim/catalyst ratio on a molar basis. All individual values and subranges from 20% to 95% of the average steady-state trim/catalyst ratio are included; for example, for the relative minimum trim/catalyst ratio can be from a lower limit of 20%, 25%, or 30% to an upper limit of 95%, 90%, or 85% of the average steady-state trim/catalyst ratio on a molar basis.

A second process ratio that can be adjusted is a comonomer to ethylene ratio. Embodiments provide that comonomer is 1-hexene; thus, the 1-hexene to ethylene ratio, which may also be referred to as 1-hexene/ethylene ratio can be adjusted. Embodiments provide that the 1-hexene/ethylene ratio is a molar ratio, i.e., moles of 1-hexene to moles of ethylene fed to the polymerization reactor.

As mentioned for a cycle of ratio adjustments, the second process ratio being adjusted, i.e., the 1-hexene/ethylene ratio, is adjusted from an average steady-state value to a relative minimum value and then to a relative maximum value prior to returning to the average steady-state value for the second process ratio.

Embodiments of the present disclosure provide that the relative minimum 1-hexene/ethylene ratio is 35% to 90% of the average steady-state 1-hexene/ethylene ratio on a molar basis. All individual values and subranges from 35% to 90% of the average steady-state 1-hexene/ethylene ratio are included; for example, for the relative minimum 1-hexene/ethylene ratio can be from a lower limit of 35%, 45%, or 55% to an upper limit of 90%, 85%, or 80% of the average steady-state 1-hexene/ethylene ratio on a molar basis.

Embodiments of the present disclosure provide that the relative maximum 1-hexene/ethylene ratio is 110% to 250% of the average steady-state 1-hexene/ethylene ratio on a molar basis. All individual values and subranges from 110% to 250% of the average steady-state 1-hexene/ethylene ratio are included; for example, for the relative maximum 1-hexene/ethylene ratio can be from a lower limit of 110%, 120%, or 125% to an upper limit of 250%, 200%, or 150% of the average steady-state 1-hexene/ethylene ratio on a molar basis.

As mentioned, utilizing a plurality of cycles of ratio adjustments can provide an improved, e.g., increased, distribution of comonomer across a high molecular weight portion of a bimodal distribution including the high molecular weight portion and a low molecular weight portion. The increased distribution of comonomer across the high molecular weight portion of the bimodal distribution is desirable for a number of applications.

Embodiments provide that a gas-phase polymerization process is utilized. Embodiments provide that the gas-phase polymerization process utilizes a single polymerization reactor, e.g., in contrast to a series of polymerization reactors as are utilized in some other polymerization processes. The gas-phase polymerization process may utilize known equipment and reaction conditions, e.g., known polymerization conditions. As discussed further herein, the bimodal catalyst system, the trim solution, ethylene, and comonomer, among other components, are fed to a gas-phase polymerization reactor to make the bimodal polyethylenes.

In making the bimodal polyethylenes with the gas-phase polymerization process, average steady-state values associated with a number of process components are achieved. For instance, embodiments provide that in making the bimodal polyethylenes, average steady-state values for reactor residence time, a trim/catalyst ratio, and a 1-hexene/ethylene ratio, among other process parameters, are achieved.

One or more embodiments provide that the trim/catalyst ratio is initially increased from the average steady-state value to a relative maximum trim/catalyst ratio and that the 1-hexene/ethylene ratio is initially decreased from the average steady-state value to a relative minimum 1-hexene/ethylene ratio. However, embodiments are not so limited; for instance, one or more embodiments provide that the trim/catalyst ratio is initially decreased from the average steady-state value to a relative minimum trim/catalyst ratio and that the 1-hexene/ethylene ratio is initially increased from the average steady-state value to a relative maximum 1-hexene/ethylene ratio.

Embodiments provide that the trim/catalyst ratio and the 1-hexene/ethylene ratio are adjusted concurrently. As used herein, “concurrently” indicates that the relative maximum trim/catalyst ratio and the relative minimum 1-hexene/ethylene ratio occur simultaneously for a time interval that is less than the average steady-state reactor residence time. Similarly, the relative minimum trim/catalyst ratio and the relative maximum 1-hexene/ethylene ratio also occur simultaneously for a time interval that is less than the average steady-state reactor residence time.

As used herein, a relative maximum ratio refers to the greatest value of that ratio within one cycle of ratio adjustment. Each cycle of ratio adjustment has one respective maximum trim/catalyst ratio and one respective maximum 1-hexene/ethylene ratio. Various cycles of ratio adjustment may have equal maximum trim/catalyst ratios and maximum 1-hexene/ethylene ratios; however, embodiments are not so limited. For instance, a number cycles of ratio adjustment may have equal maximum trim/catalyst ratios and/or maximum 1-hexene/ethylene ratios, while a number of cycles of ratio adjustment may have different maximum trim/catalyst ratios and/or maximum 1-hexene/ethylene ratios.

One or more embodiments provide that for each of the plurality of cycles of ratio adjustment, each respective maximum trim/catalyst ratio is with 10% of one another. For instance, for each of the plurality of cycles of ratio adjustment, each respective maximum trim/catalyst ratio can be from 0%, i.e. equal to, to 10% of one another. All individual values and subranges from 0% to 10% are included; for example, for each of the plurality of cycles of ratio adjustment, each respective maximum trim/catalyst ratio can be from a lower limit of 0%, 1%, or 2% to an upper limit of 10%, 9%, or 8% of one another. In other words, for each of the plurality of cycles of ratio adjustment no two maximum trim/catalyst ratios are more than 10% apart from one another.

One or more embodiments provide that for each of the plurality of cycles of ratio adjustment, each respective maximum 1-hexene/ethylene ratio is with 10% of one another. For instance, for each of the plurality of cycles of ratio adjustment, each respective maximum 1-hexene/ethylene ratio can be from 0%, i.e. equal to, to 10% of one another. All individual values and subranges from 0% to 10% are included; for example, for each of the plurality of cycles of ratio adjustment, each respective maximum 1-hexene/ethylene ratio can be from a lower limit of 0%, 1%, or 2% to an upper limit of 10%, 9%, or 8% of one another. In other words, for each of the plurality of cycles of ratio adjustment no two maximum 1-hexene/ethylene ratios are more than 10% apart from one another.

As used herein, a relative minimum ratio refers to the lowest value of that ratio within one cycle of ratio adjustment. Each cycle of ratio adjustment has one respective minimum trim/catalyst ratio and one respective minimum 1-hexene/ethylene ratio. Various cycles of ratio adjustment may have equal minimum trim/catalyst ratios and minimum 1-hexene/ethylene ratios; however, embodiments are not so limited. For instance, a number cycles of ratio adjustment may have equal minimum trim/catalyst ratios and/or minimum 1-hexene/ethylene ratios, while a number of cycles of ratio adjustment may have different minimum trim/catalyst ratios and/or minimum 1-hexene/ethylene ratios.

One or more embodiments provide that for each of the plurality of cycles of ratio adjustment, each respective minimum 1-hexene/ethylene ratio is with 10% of one another. For instance, for each of the plurality of cycles of ratio adjustment, each respective minimum 1-hexene/ethylene ratio can be from 0%, i.e. equal to, to 10% of one another. All individual values and subranges from 0% to 10% are included; for example, for each of the plurality of cycles of ratio adjustment, each respective minimum 1-hexene/ethylene ratio can be from a lower limit of 0%, 1%, or 2% to an upper limit of 10%, 9%, or 8% of one another. In other words, for each of the plurality of cycles of ratio adjustment no two minimum 1-hexene/ethylene ratios are more than 10% apart from one another.

One or more embodiments provide that for each of the plurality of cycles of ratio adjustment, each respective minimum trim/catalyst ratio is with 10% of one another. For instance, for each of the plurality of cycles of ratio adjustment, each respective minimum trim/catalyst ratio can be from 0%, i.e., equal to, to 10% of one another. All individual values and subranges from 0% to 10% are included; for example, for each of the plurality of cycles of ratio adjustment, each respective minimum trim/catalyst ratio can be from a lower limit of 0%, 1%, or 2% to an upper limit of 10%, 9%, or 8% of one another. In other words, for each of the plurality of cycles of ratio adjustment no two minimum trim/catalyst ratios are more than 10% apart from one another.

Embodiments provide that each cycle of ratio adjustment includes increasing the average steady-state trim/catalyst ratio to a relative maximum trim/catalyst ratio over a time interval that is from 5% to 15% of the average steady-state reactor residence time, while concurrently decreasing the average steady-state 1-hexene/ethylene ratio to a relative minimum 1-hexene/ethylene ratio. The relative maximum trim/catalyst ratio and the relative minimum 1-hexene/ethylene ratio occur simultaneously. All individual values and subranges from 5% to 15% of the average steady-state reactor residence time are included; for example, the average steady-state trim/catalyst ratio can be increased to a relative maximum trim/catalyst ratio and the average steady-state 1-hexene/ethylene ratio can be decreased to the relative minimum 1-hexene/ethylene ratio from a lower limit of 5%, 6%, 7%, or 8% to an upper limit of 15%, 14%, 13%, or 12% of the average steady-state reactor residence time.

Embodiments provide that each cycle of ratio adjustment includes decreasing the relative maximum trim/catalyst ratio to a relative minimum trim/catalyst ratio over a time interval that is from 10% to 30% of the average steady-state reactor residence time, while concurrently increasing the relative minimum 1-hexene/ethylene ratio to a relative maximum 1-hexene/ethylene ratio. The relative minimum trim/catalyst ratio and the relative maximum 1-hexene/ethylene ratio occur simultaneously. All individual values and subranges from 10% to 30% of the average steady-state reactor residence time are included; for example, the relative maximum trim/catalyst ratio can be decreased to a relative minimum trim/catalyst ratio and the relative minimum 1-hexene/ethylene ratio can be increased to the relative maximum 1-hexene/ethylene ratio from a lower limit of 10%, 11%, 12%, or 15% to an upper limit of 30%, 28%, 27%, or 25% of the average steady-state reactor residence time.

Embodiments provide that each cycle of ratio adjustment includes increasing the relative minimum trim/catalyst ratio to the average steady-state trim/catalyst ratio over a time interval that is from 5% to 15% of the average steady-state reactor residence time, while concurrently decreasing the relative maximum 1-hexene/ethylene ratio to the average steady-state 1-hexene/ethylene ratio. All individual values and subranges from 5% to 15% of the average steady-state reactor residence time are included; for example, the relative minimum trim/catalyst ratio can be increased to the average steady-state trim/catalyst ratio and the relative maximum 1-hexene/ethylene ratio can be decreased to the average steady-state 1-hexene/ethylene ratio from a lower limit of 5%, 6%, 7%, or 8% to an upper limit of 15%, 14%, 13%, or 12% of the average steady-state reactor residence time.

Embodiments provide that each cycle of ratio adjustment can be from 20% to 60% of the average steady-state reactor residence time. All individual values and subranges from 20% to 55% of the average steady-state reactor residence time are included; for example, each cycle of ratio adjustment can be from a lower limit of 20%, 23%, 26%, or 31% to an upper limit of 60%, 56%, 53%, or 49% of the average steady-state reactor residence time.

Embodiments of the present disclosure provide that the plurality of cycles of ratio adjustment can include from 10 to 100 cycles of ratio adjustment. All individual values and subranges from 10 to 100 cycles of ratio adjustment are included; for example, the plurality of cycles of ratio adjustment can be from a lower limit of 10, 12, or 15 cycles of ratio adjustment to an upper limit of 100, 75, 50, or 35 cycles of ratio adjustment.

The relative amounts of the pre-catalysts can be adjusted by adding one of the components (via the trim solution) to a catalyst mixture such as a bimodal polymerization catalyst system en-route to the reactor in a known process that is referred to as “trim”.

As mentioned, embodiments provide that the bimodal catalyst system includes a high molecular weight (HMW) polyethylene component and a low molecular weight (LMW) polyethylene component. In some aspects the bimodal catalyst system has only two catalysts, and is prepared from two and only two procatalyst compounds. One of the catalyst compounds may be a metallocene catalyst compound and the other a non-metallocene catalyst compound. One of the catalyst compounds yields, under the (co)polymerizing conditions, the lower molecular weight (LMW) polyethylene component and the other catalyst compound yields the higher molecular weight (HMW) polyethylene component.

The catalyst system may be made by contacting at least two procatalysts having different structures from each other with at least one activator. Each procatalyst may independently comprise a metal atom, at least one ligand bonded to the metal atom, and at least one leaving group bonded to and displaceable from the metal atom. Each metal may be an element of any one of Groups 3 to 14, e.g., a Group 4 metal. Each leaving group is H, an unsubstituted alkyl, an aryl group, an aralkyl group, a halide atom, an alkoxy group, or a primary or secondary amino group. In metallocenes, at least one ligand is a cyclopentadienyl or substituted cyclopentadienyl group. In non-metallocenes, no ligand is a cyclopentadienyl or substituted cyclopentadienyl group, and instead at least one ligand has at least one O, N, and/or P atom that coordinates to the metal atom. Typically the ligand(s) of the non-metallocene has at least two 0, N, and/or P atoms that coordinates in a multidentate (e.g., bidentate or tridentate) binding mode to the metal atom. Discrete structures means the procatalysts and catalysts made therefrom have different ligands from each other, and either the same or a different metal atom, and either the same or different leaving groups.

One of the procatalysts, useful for making a catalyst of the catalyst system and/or making the trim solution, may be a metallocene compound of any one of formulas (I) to (IX) and another of the procatalysts may be a non-metallocene of any one of formulas (A) and (B), as shown below.

For formula (I), each of the R¹ to R¹⁰ groups is independently H, a (C₁-C₂₀)alkyl, (C₆-C₂₀)aryl, or (C₇-C₂₀)aralkyl group; M is a Group 4 metal; and each X is independently H, a halide, (C₁-C₂₀)alkyl or (C₇-C₂₀)aralkyl group. In some aspects each of R⁷ to R¹⁰ is H.

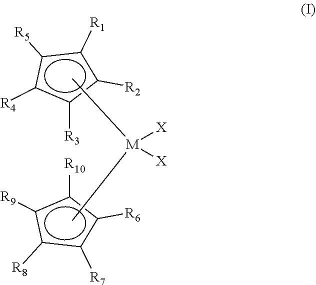

For formula (II), each of the R¹ to R⁶ groups is independently H, a (C₁-C₂₀)alkyl, (C₆-C₂₀)aryl, or (C₇-C₂₀)aralkyl group; M is a Group 4 metal, e.g., Ti, Zr, or Hf; and each X is independently H, a halide, (C₁-C₂₀)alkyl or (C₇-C₂₀)aralkyl group.

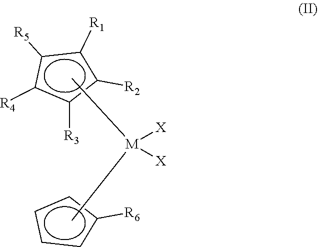

For formula (III), each of the R¹ to R¹² groups is independently H, a (C₁-C₂₀)alkyl, (C₆-C₂₀)aryl, or (C₇-C₂₀)aralkyl group, wherein at least one of R⁴ to R⁷ is not H; M is a Group 4 metal, e.g., Ti, Zr, or Hf; and each X is independently H, a halide, (C₁-C₂₀)alkyl or (C₇-C₂₀)aralkyl group. In some aspects each of R⁹ to R¹² is H.

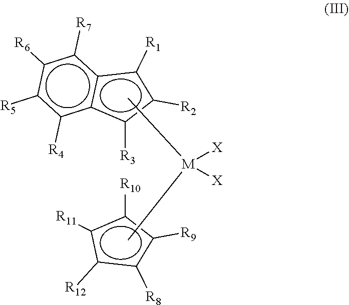

In some aspects each X in formulas (I) to (Ill) is independently a halide, (C₁-C₄)alkyl, or benzyl; alternatively Cl or benzyl. In some aspects each halide in formulas (I) to (Ill) is independently Cl, Br, or I; alternatively Cl or Br; alternatively Cl. In some aspects each M in formulas (I) to (Ill) is independently Ti, Zr, or Hf; alternatively Zr or Hf; alternatively Ti; alternatively Zr; alternatively Hf.

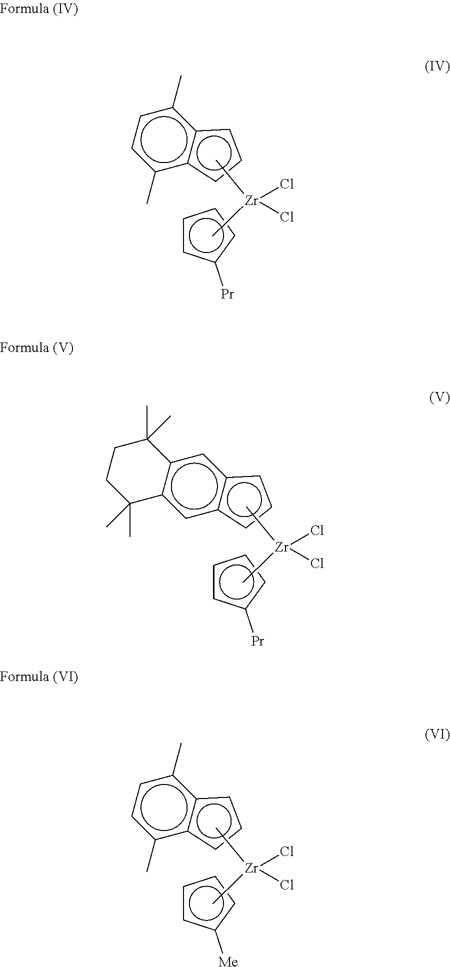

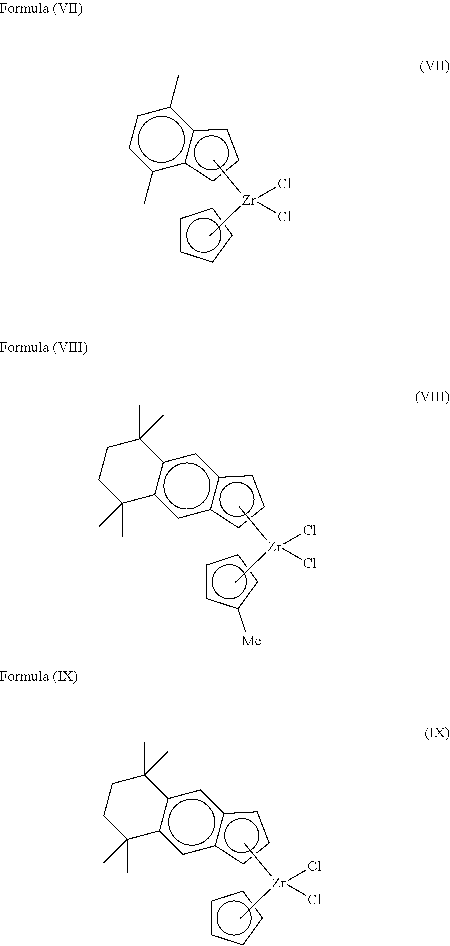

In formulas (IV) to (IX), Me is methyl (CH₃), Pr is propyl (i.e., CH₂CH₂CH₃), and each “I” substituent on a ring represents a methyl group.

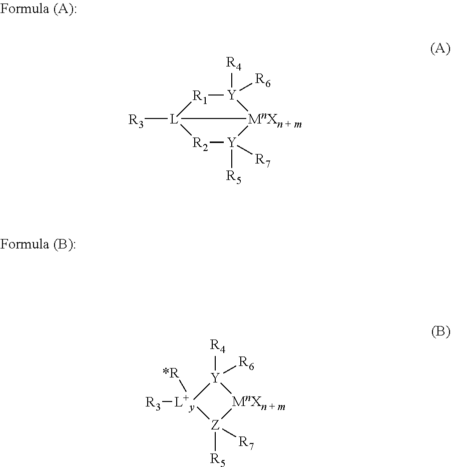

In formulas (A) and (B), M is a Group 3 to 12 transition metal atom or a Group 13 or 14 main group metal atom, or a Group 4, 5, or 6 metal atom. M may be a Group 4 metal atom, alternatively Ti, Zr, or Hf; alternatively Zr or Hf; alternatively Zr. Each X is independently a leaving group, such as an anionic leaving group. Subscript y is 0 or 1; when y is 0 group L′ is absent. Subscript n represents the formal oxidation state of metal atom M and is +3, +4, or +5; alternatively, n is +4. L is a Group 15 or 16 element, such as nitrogen or oxygen; L′ is a Group 15 or 16 element or Group 14 containing group, such as carbon, silicon or germanium. Y is a Group 15 element, such as nitrogen or phosphorus; alternatively nitrogen. Z is a Group 15 element, such as nitrogen or phosphorus; alternatively nitrogen. Subscript m is 0, −1, −2, or −3; alternatively, −2; and represents the total formal charge of the Y, Z, and L in formula (A) and the total formal charge of the Y, Z, and L′ in formula (B). R¹, R², R³, R⁴, R⁵, R⁶, and R⁷ are independently H, a (C₁-C₂₀)hydrocarbyl group, a (C₁-C₂₀)heterohydrocarbyl group, or a (C₁-C₂₀)organoheteryl group, wherein the (C₁-C₂₀)heterohydrocarbyl group and (C₁-C₂₀)organoheteryl group each independently have at least one heteroatom selected from Si, Ge, Sn, Pb, or P. Alternatively, R¹ and R² are covalently bonded to each other to form a divalent group of formula —R^{1a}—R^{2a}— and/or R⁴ and R⁵ are covalently bonded to each other to form a divalent group of formula —R^{4a}—R^{5a}—, wherein —R^{1a}—R^{2a}— and —R^{4a}—R^{5a}—.are independently a (C₁-C₂₀)hydrocarbylene group, a (C₁-C₂₀)heterohydrocarbylene group, or a (C₁-C₂₀)organoheterylene group. R³ may be absent; alternatively R³ is H, a halogen atom, a (C₁-C₂₀)hydrocarbyl group, a (C₁-C₂₀)heterohydrocarbyl group, or a (C₁-C₂₀)organoheteryl group. R³ is absent if, for example, L is O, H, or an alkyl group. R⁴ and R⁵ may be a (C₁-C₂₀)alkyl group, a (C₆-C₂₀)aryl group, a substituted (C₆-C₂₀)aryl group, a (C₃-C₂₀)cycloalkyl group, a substituted (C₃-C₂₀)cycloalkyl group, a (C₈-C₂₀)bicyclic aralkyl group, or a substituted (C₈-C₂₀)bicyclic aralkyl group. R⁶ and R⁷ may be H or absent. R* may be absent, or may be a hydrogen, a Group 14 atom containing group, a halogen, or a heteroatom containing group.

In some aspects the catalyst system may comprise a combination of a metallocene catalyst compound and a non-metallocene catalyst compound. The metallocene catalyst compound may be a metallocene ligand-metal complex such as a metallocene ligand-Group 4 metal complex, which may be made by activating (with an activator) a procatalyst compound selected from (pentamethylcyclopentadienyl)(n-propylcyclopentadienyl)zirconium dichloride, bis(n-butylcyclopentadienyl)zirconium dichloride, (pentamethylcyclopentadienyl)(n-propylcyclopentadienyl)zirconium dimethyl, and bis(n-butylcyclopentadienyl)zirconium dimethyl. The non-metallocene catalyst compound may be a non-metallocene ligand-metal complex such as a non-metallocene ligand-Group 4 metal complex, which may be made by activating (with the activator) a procatalyst compound selected from bis(2-(2,4,6-trimethylphenylamido)ethyl)amine zirconium dibenzyl and bis(2-(pentamethylphenylamido)ethyl)amine zirconium dibenzyl.

In some aspects the catalyst system may be made by activating, according to a method of contacting with an activator, a combination of a metallocene procatalyst compound that is (tetramethylcyclopentadienyl)(n-propylcyclopentadienyl)zirconium dichloride and a non-metallocene procatalyst compound that is bis(2-pentamethylphenylamido)ethyl)amine zirconium dibenzyl. The (tetramethylcyclopentadienyl)(n-propylcyclopentadienyl)zirconium dichloride is a compound of formula (II) wherein M is Zr, each X is Cl, R⁶ is propyl (CH₂CH₂CH₃), and each of R¹ to R⁴ is methyl. The bis(2-pentamethylphenylamido)ethyl)amine zirconium dibenzyl is a procatalyst compound of formula (A) wherein M is Zr, each X is benzyl, R¹ and R² are each CH₂CH₂; R³ is H; L, Y, and Z are all N; and R⁴ and R⁵ are each pentamethylphenyl; and R⁶ and R⁷ are absent.

Each of the catalyst compounds of the catalyst system independently may be unsupported, alternatively supported on a support material, in which latter case the catalyst system is a supported catalyst system. When each catalyst compound is supported, the catalyst compounds may reside on the same support material, e.g., same particles, or on different support materials, e.g., different particles. The catalyst system can include mixtures of unsupported catalyst compounds in slurry form and/or solution form. The support material may be a silica, e.g., fumed silica, alumina, a clay, or talc. The fumed silica may be hydrophilic (untreated), alternatively hydrophobic (treated). In some aspects the support is the hydrophobic fumed silica, which may be prepared by treating an untreated fumed silica with a treating agent such as dimethyldichlorosilane, a polydimethylsiloxane fluid, or hexamethyldisilazane. In some aspects the treating agent is dimethyldichlorosilane.

In some aspects the bimodal catalyst system can be the bimodal catalyst system as described in any one of the following references: U.S. Pat. No. 7,193,017 B2; U.S. Pat. No. 7,312,279 B2; U.S. Pat. No. 7,858,702 B2; U.S. Pat. No. 7,868,092 B2; U.S. Pat. No. 8,202,940 B2; and U.S. Pat. No. 8,378,029 B2, e.g., column 4/line 60 to column 5/line 10 and column 10/lines 6 to 38 and Example 1.

The catalyst system may be fed into the polymerization reactor(s) in “dry mode” or “wet mode”, alternatively dry mode, alternatively wet mode. The dry mode is fed in the form of a dry powder or granules. The wet mode is fed in the form of a suspension of the catalyst system in an inert liquid such as mineral oil. The catalyst system is commercially available under the PRODIGY™ Bimodal Catalysts brand, e.g., BMC-200, from Univation Technologies, LLC.

As mentioned, embodiments provide that a trim composition, which may also be referred to as a trim solution, is utilized. Embodiments provide that the trim composition can include any one of the metallocene procatalyst compounds or the nonmetallocene procatalyst compounds described earlier (e.g., formulas (1)-(IX) and (A)-(B)) dissolved in an inert liquid solvent, such as a liquid alkane. The trim composition can be a solution. The trim composition can be mixed with the catalyst system to make the mixture, and the mixture can be used in the polymerization reaction discussed herein. In general, trim compositions have been used to modify at least one property of polyethylene composition. This modification to the at least one property of polyethylene composition has previously been made by maintaining the relative amounts, e.g., maintaining a steady-state, of catalyst system and trim composition being fed to the polymerization reactor. Examples of such at least one property are density, melt index I₂, flow index I₂₁. melt flow ratio (I₂₁/I₂), and molecular mass dispersity (M_{w}/Mₙ). The mixture of the catalyst system and the trim composition may be fed into the polymerization reactor in “wet mode”, alternatively may be devolatilized and fed in “dry mode”. The dry mode is fed in the form of a dry powder or granules. When mixture contains a solid support, the wet mode is fed in the form of a suspension or slurry. In some aspects the inert liquid is a liquid alkane such as heptane.

As used herein, when the bimodal polyethylene is referred to as comprising, e.g., being made from, an olefin, the olefin present in such bimodal polyethylene is the polymerized form of the olefin. For example, when the bimodal polyethylene is said to have an ethylene content of 75 wt % to 95 wt %, it is understood that the polymer unit in the bimodal polyethylene is derived from ethylene in the polymerization reaction(s) and the derived units are present at 75 wt % to 95 wt %, based upon the total weight of the polymer.

Examples of the bimodal polyethylenes include ethylene-based copolymers, having at least 50 wt % ethylene. One or more embodiments provide that the bimodal polyethylenes can include from 50 to 99.9 wt % of units derived from ethylene based on a total weight of the bimodal polyethylene. All individual values and subranges from 50 to 99.9 wt % are included; for example, the bimodal polyethylene can include from a lower limit of 50, 60, 70, 80, or 90 wt % of units derived from ethylene to an upper limit of 99.9, 99.7, 99.4, 99, 96, 93, 90, or 85 wt % of units derived from ethylene based on the total weight of the bimodal polyethylene. The bimodal polyethylenes can include from 0.1 to 50 wt % of units derived from comonomer based on the total weight of the bimodal polyethylene. One or more embodiments provide that ethylene is utilized as a monomer and 1-hexene is utilized as a comonomer.

The bimodal polyethylenes discussed herein may be utilized for a number of applications including, but not limited to, molded articles, extruded articles, films, fibers, nonwoven fabrics and/or woven fabrics.

A number of aspects of the present disclosure are provided as follows.

Aspect 1 provides a method of making bimodal polyethylenes, the method comprising: feeding a bimodal catalyst system and a trim solution to a single reactor to establish an average steady-state trim/catalyst ratio, wherein the reactor has an average steady-state reactor residence time; feeding ethylene and 1-hexene to the reactor to establish an average steady-state 1-hexene/ethylene ratio; and performing a plurality of cycles of ratio adjustment, wherein each cycle of ratio adjustment comprises: increasing the average steady-state trim/catalyst ratio to a relative maximum trim/catalyst ratio over a time interval that is from 5% to 15% of the average steady-state reactor residence time, while concurrently decreasing the average steady-state 1-hexene/ethylene ratio to a relative minimum 1-hexene/ethylene ratio; decreasing the relative maximum trim/catalyst ratio to a relative minimum trim/catalyst ratio over a time interval that is from 10% to 30% of the average steady-state reactor residence time, while concurrently increasing the relative minimum 1-hexene/ethylene ratio to a relative maximum 1-hexene/ethylene ratio; and increasing the relative minimum trim/catalyst ratio to the average steady-state trim/catalyst ratio over a time interval that is from 5% to 15% of the average steady-state reactor residence time, while concurrently decreasing the relative maximum 1-hexene/ethylene ratio to the average steady-state1-hexene/ethylene ratio.

Aspect 2 provides the method of Aspect 1, wherein the plurality of cycles of ratio adjustment includes 10 to 100 cycles of ratio adjustment.

Aspect 3 provides the method of Aspect 1 and/or Aspect 2, wherein the bimodal catalyst system includes a low molecular weight component and a high molecular weight component, and the trim solution includes the low molecular weight component.

Aspect 4 provides the method of Aspect 1, Aspect 2, and/or Aspect 3, wherein the relative maximum trim/catalyst ratio is 105% to 300% of the average steady-state trim/catalyst ratio on a molar basis.

Aspect 5 provides the method of Aspect 1, Aspect 2, Aspect 3, and/or Aspect 4, wherein the relative minimum trim/catalyst ratio is 20% to 95% of the average steady-state trim/catalyst ratio on a molar basis.

Aspect 6 provides the method of Aspect 1, Aspect 2, Aspect 3, Aspect 4, and/or Aspect 5, wherein the relative maximum 1-hexene/ethylene is 110% to 250% of the average steady-state 1-hexene/ethylene on a molar basis.

Aspect 7 provides the method of Aspect 1, Aspect 2, Aspect 3, Aspect 4, Aspect 5, and/or Aspect 6, wherein the relative minimum 1-hexene/ethylene is 35% to 90% of the average steady-state 1-hexene/ethylene ratio on a molar basis.

### Examples

Bimodal catalyst system 1: consisted essentially of or made from bis(2-pentamethylphenylamido)ethyl)amine zirconium dibenzyl and (tetramethylcyclopentadienyl)(n-propylcyclopentadienyl)zirconium dichloride spray-dried in a 3:1 molar ratio onto CAB-O-SIL TS610, a hydrophobic fumed silica made by surface treating hydrophilic (untreated) fumed silica with dimethyldichlorosilane support, and methylaluminoxane (MAO), and fed into a gas phase polymerization reactor as a slurry in mineral oil. The molar ratio of moles MAO to (moles of bis(2-pentamethylphenylamido)ethyl)amine zirconium dibenzyl+moles (tetramethylcyclopentadienyl)(n-propylcyclopentadienyl)zirconium dichloride) was 140:1. Bimodal catalyst system 1 had a concentration (catalyst slurry concentration) of 21.7 weight percent.

Trim solution 1: consisted essentially of or made from (tetramethylcyclopentadienyl)(n-propylcyclopentadienyl)zirconium dimethyl (procatalyst) dissolved in heptane to give a solution having a concentration of 0.04 weight percent of procatalyst.

Example 1, a copolymerization with a plurality of cycles of ratio adjustment, was performed as follows. Bimodal catalyst system 1 and trim solution 1 were utilized to copolymerize ethylene and 1-hexene to make a bimodal polyethylene composition. A single gas phase polymerization reactor containing a pilot plant scale continuous mode, gas phase fluidized bed reactor with a capacity of producing 22 to 110 kg resin per hour was utilized. For an experimental run, before startup, the reactor was preloaded with a seedbed of granular resin inside. The reactor was dried with nitrogen such that the seedbed was below 5 ppm moisture. Then, reaction constituent gases were introduced to the reactor to build a gas phase condition. At the same time heated the reactor up to the desired temperature. The reactor was charged with hydrogen gas sufficient to produce a desired molar ratio of hydrogen to ethylene at the reaction conditions and charged with 1-hexene to produce a desired molar ratio of 1-hexene to ethylene at reaction conditions. The reactor was pressurized with ethylene to provide a desired reactor temperature and the reactor was maintained at the reaction temperature. Once the (co)polymerizing conditions were reached, a feed of a slurry of Bimodal Catalyst System 1 was injected into the reactor. A Trim Solution 1 feed was mixed with the feed of Bimodal Catalyst System I to give a mixture thereof, which was then fed into the reactor Approximately three bed turnovers were utilized to reach steady-state production of the bimodal polyethylene. Average steady-state conditions are reported below in Table 1.

For Example 1, once average steady-state conditions were reached, the trim/catalyst ratio was increased from the average steady-state trim/catalyst ratio of 1.09 mol/mol for a time interval of approximately 9.5% of the reactor residence time (15 minutes) to a relative maximum trim/catalyst ratio of 1.27 mol/mol; the relative maximum trim/catalyst ratio was approximately 117% of the average steady-state trim/catalyst ratio. While the trim/catalyst ratio was increased from the steady-state ratio, the average steady-state 1-hexene/ethylene ratio (0.0048 mol/mol) was concurrently decreased from the average steady-state, also over 15 minutes, by stopping the 1-hexene feed to the reactor, to provide a relative minimum 1-hexene/ethylene ratio; the relative minimum 1-hexene/ethylene ratio was approximately 0.0033 mol/mol (the relative minimum 1-hexene/ethylene ratio was approximately 69% of the average steady-state 1-hexene/ethylene ratio ratio).

Following the time interval of approximately 9.5% of the reactor residence time (e.g., when the relative maximum trim/catalyst ratio and relative minimum 1-hexene/ethylene ratio were achieved), the trim/catalyst ratio was decreased to a relative minimum trim/catalyst ratio of 0.91 mol/mol; the relative minimum trim/catalyst ratio was approximately 84% of the average steady-state trim/catalyst ratio, for a time interval of approximately 19% of the reactor residence time (30 minutes). While the trim/catalyst ratio was decreased, the 1-hexene/ethylene ratio was concurrently increased, also over 30 minutes, to a relative maximum (corresponding to a 1-hexene/ethylene ratio of 0.0062 mol/mol; the relative maximum 1-hexene/ethylene ratio was approximately 130% of the average steady-state 1-hexene/ethylene ratio ratio) by increasing the 1-hexene feed to the reactor.

Following the time interval of approximately 19% of the reactor residence time (e.g., when the relative minimum trim/catalyst ratio and relative maximum 1-hexene/ethylene ratio were achieved) the trim/catalyst ratio was increased for a time interval of approximately 9.5% of the reactor residence time to reach the steady-state trim/catalyst ratio and the 1-hexene to ethylene ratio was decreased to reach the steady-state 1-hexene to ethylene ratio to complete one cycle of ratio adjustment.

For Example 1, seventeen cycles of ratio adjustment were performed. Each cycle of ratio adjustment was completed in approximately in a cycle time interval of approximately 38% of the reactor residence time (1 hour).

Example 2, a copolymerization with a plurality of cycles of ratio adjustment, was performed as follows. Example 2 was performed as Example 1 with the change that for Example 2, once an average steady-state trim/catalyst ratio (1.54 mol/mol) and an average steady-state 1-hexene/ethylene ratio (0.0045 mol/mol) were reached, the trim/catalyst ratio was increased from the average steady-state trim/catalyst ratio to a relative maximum trim/catalyst ratio of 2.54 mol/mol; the relative maximum trim/catalyst ratio was approximately 165% of the average steady-state trim/catalyst ratio, over a time interval of approximately 9.5% of the reactor residence time (15 minutes). While the trim/catalyst ratio was increased from the average steady-state ratio, the average steady-state 1-hexene/ethylene ratio (0.0045 mol/mol) was also decreased to a relative minimum, over the time interval of approximately 9.5% of the reactor residence time (15 minutes), by stopping the 1-hexene feed to the reactor; the relative minimum 1-hexene/ethylene ratio was approximately 0.033 mol/mol (the relative minimum 1-hexene/ethylene ratio was approximately 73% of the average steady-state 1-hexene/ethylene ratio ratio).

Following the time interval of approximately 9.5% of the reactor residence time (e.g., when the relative maximum trim/catalyst ratio and the relative minimum 1-hexene/ethylene ratio were achieved), the trim/catalyst ratio was decreased to a relative minimum trim/catalyst ratio of 0.53 mol/mol; the relative minimum trim/catalyst ratio was approximately 34% of the average steady-state trim/catalyst ratio, over a time interval of approximately 19% of the reactor residence time (30 minutes). While the trim/catalyst ratio was decreased, the average steady-state 1-hexene/ethylene ratio was also increased to a relative maximum 1-hexene/ethylene ratio (0.0059 mol/mol; the relative maximum 1-hexene/ethylene ratio was approximately 131% of the average steady-state 1-hexene/ethylene ratio ratio) over the time interval of approximately 19% of the reactor residence time (30 minutes), by increasing the 1-hexene feed to the reactor to complete one cycle of ratio adjustment.

Following the time interval of approximately 19% of the reactor residence time (e.g., when the relative minimum trim/catalyst ratio and relative maximum 1-hexene/ethylene ratio were achieved) the trim/catalyst ratio was increased for a time interval of approximately 9.5% of the reactor residence time to reach the steady-state trim/catalyst ratio and the 1-hexene to ethylene ratio was decreased to reach the steady-state 1-hexene to ethylene ratio to complete one cycle of ratio adjustment.

For Example 2, seventeen cycles of ratio adjustment were performed. Each cycle of ratio adjustment was completed in approximately in a cycle time interval of approximately 38% of the reactor residence time (1 hour).

Comparative Example A was performed as follows. Comparative Example A was performed as Example 1 with the change that no cycles, i.e. zero cycles, of ratio adjustment were performed. In other words, for Comparative Example A, steady-state values were maintained.

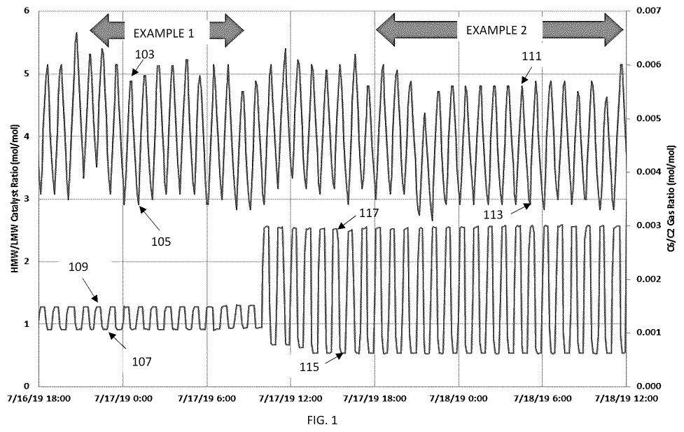

FIG. 1 is a plot of trim/catalyst ratios and 1-hexene/ethylene ratios in accordance with a number of embodiments of the present disclosure.

As shown in FIG. 1, Example 1 includes a plurality of cycles of ratio adjustment. As shown in FIG. 1, each cycle of ratio adjustment includes a relative maximum trim/catalyst ratio 103 and a relative minimum trim/catalyst ratio 105. Also, each cycle of ratio adjustment includes a relative minimum 1-hexene/ethylene ratio 107 and a relative maximum 1-hexene/ethylene ratio 109.

As shown in FIG. 1, Example 2 includes a plurality of cycles of ratio adjustment. As shown in FIG. 1, each cycle of ratio adjustment includes a relative maximum trim/catalyst ratio 111 and a relative minimum trim/catalyst ratio 113. Also, each cycle of ratio adjustment includes a relative minimum 1-hexene/ethylene ratio 115 and a relative maximum 1-hexene/ethylene ratio 117.

TABLE 1

| | | | Comparative |
|---|---|---|---|
| | Example 1 | Example 2 | Example A |
| | Average steady-state values | | Steady-state values |
| Trim to catalyst | 4.3 | 4.4 | 4.3 |
| ratio (mL/mL_) | | | |
| Production rate | 35.3 | 35.8 | 35.7 |
| (lb/hr) | | | |
| Residence time | 2.64 | 2.61 | 2.57 |
| (hr) | | | |
| Reaction | 105.0 | 105.0 | 105.0 |
| temperature | | | |
| (° C.) | | | |
| Reactor pressure | 348.8 | 348.8 | 348.9 |
| (psig) | | | |
| Ethylene partial | 220.0 | 220.0 | 220.2 |
| pressure | | | |
| (psig) | | | |
| 1-hexene to | 0.0048 | 0.0045 | 0.0045 |
| ethylene ratio | | | |
| (mol/mol) | | | |
| hydrogen to | 0.0020 | 0.0020 | 0.0020 |
| ethylene ratio | | | |
| (mol/mol) | | | |

A number of properties were determined for the bimodal polyethylenes made by Example 1, Example 2, and Comparative Example A and are reported in Table 2.15˜ flow index (190° C., 5.0 kg) was determined according to ASTM 01238-13; I₂₁ flow index (190°

TABLE 2

| | | | Comparative |
|---|---|---|---|
| | Example 1 | Example 2 | Example A |
| I₅ (g/10 min) | 0.18 | 0.18 | 0.19 |
| I₂₁ (g/10 min) | 6.58 | 6.48 | 7.24 |
| I₂₁/1₅ | 36.22 | 36.14 | 37.15 |
| Mass balance productivity | 12914 | 12794 | 12955 |
| (lb bimodal polyethylene/ | | | |
| lb catalyst) | | | |

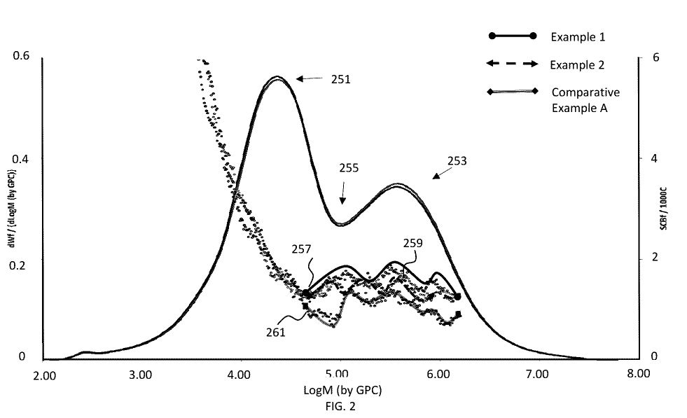

FIG. 2 is a Gel Permeation Chromatogram (GPC) of bimodal polyethylenes made in accordance with a number of embodiments of the present disclosure. FIG. 2 includes bimodal polyethylenes made by Example 1, Example 2, and Comparative Example A.

As shown in FIG. 2, each of the bimodal polyethylenes made by Example 1, Example 2, and Comparative Example A have a low molecular weight portion 251, which may be referred to as a low molecular weight mode, and a high molecular weight portion 253, which may be referred to as a high molecular weight mode.

The bimodal polyethylenes may be characterized by the two peaks associated respectively with the low molecular weight portion 251 and high molecular weight portion 253, where the peaks are separated by a distinguishable local minimum 255 therebetween in a plot of dW/dLog(MW) on the y-axis versus Log(MW) on the x-axis to give a Gel Permeation Chromatograph (GPC) chromatogram, wherein Log(MW) and dW/dLog(MW) are as defined herein and are measured by Gel Permeation Chromatograph (GPC) Test Method described below.

Gel permeation chromatography (GPC) Test Method: Weight-Average Molecular Weight Test Method: determine M_{w}, number-average molecular weight (Mₙ), and M_{w}/Mnusing chromatograms obtained on a High Temperature Gel Permeation Chromatography instrument (HTGPC, Polymer Laboratories). The HTGPC is equipped with transfer lines, a differential refractive index detector (DRI), and three Polymer Laboratories PLgel 1 10 μm Mixed-B columns, all contained in an oven maintained at 160° C. Method uses a solvent composed of BHT-treated TCB at nominal flow rate of 1.0 milliliter per minute (mL/min) and a nominal injection volume of 300 microliters (μL). Prepare the solvent by dissolving 6 grams of butylated hydroxytoluene (BHT, antioxidant) in 4 liters (L) of reagent grade 1,2,4-trichlorobenzene (TCB), and filtering the resulting solution through a 0.1 micrometer (μm) PTFE filter to give the solvent. PTFE is poly(tetrafluoroethylene). Degas the solvent with an inline degasser before it enters the HTGPC instrument. Calibrate the columns with a series of monodispersed polystyrene (PS) standards. Separately, prepare known concentrations of test polymer dissolved in solvent by heating known amounts thereof in known volumes of solvent at 160° C. with continuous shaking for 2 hours to give solutions. (Measure all quantities gravimetrically.) Target solution concentrations, c, of test polymer of from 0.5 to 2.0 milligrams polymer per milliliter solution (mg/mL), with lower concentrations, c, being used for higher molecular weight polymers. Prior to running each sample, purge the DRI detector. Then increase flow rate in the apparatus to 1.0 mL/min, and allow the DRI detector to stabilize for 8 hours before injecting the first sample. Calculate M_{w} and Mₙ using universal calibration relationships with the column calibrations. Calculate M_{W} at each elution volume with following equation

$$\\ log {M}_{x} = \frac{log ( {K}_{x} / {K}_{PS} )}{{a}_{x} + 1} + \frac{{a}_{PS} + 1}{{a}_{x} + 1} log {M}_{PS}$$

where subscript “X” stands for the test sample, subscript “PS” stands for PS standards, a_{PS}=0.61, K_{PS}=0.000175, and aₓ and Kₓ are obtained from published literature. For polyethylenes, aₓ/Kx0.695/0.000579. For polypropylenes aₓ/Kₓ0.705/0.0002288. At each point in the resulting chromatogram, calculate concentration, c, from a baseline-subtracted DRI signal, I_{DRI}, using the following equation: c=K_{DR}|I_{DRI}/(dn/dc), wherein K_{DR}| is a constant determined by calibrating the DRI, / indicates division, and dn/dc is the refractive index increment for the polymer. For polyethylene, dn/dc=0.109. Calculate mass recovery of polymer from the ratio of the integrated area of the chromatogram of concentration chromatography over elution volume and the injection mass which is equal to the pre-determined concentration multiplied by injection loop volume.

Report all molecular weights in grams per mole (g/mol) unless otherwise noted. Further details regarding methods of determining M_{w}, Mₙ, MWD are described in US 2006/0173123 page 24-25, paragraphs [0334] to [0341]. Plot of dW/dLog(MW) on the y-axis versus Log(MW) on the x-axis to give a GPC chromatogram, wherein Log(MW) and dW/dLog(MW) are as discussed herein.

Bimodality Test Method: determine presence or absence of resolved bimodality by plotting dWf/dLogM (mass detector response) on y-axis versus LogM on the x-axis to obtain a GPC chromatogram curve containing local maxima log(MW) values for LMW and HMW polyethylene component peaks, and observing the presence or absence of a local minimum between the LMW and HMW polyethylene component peaks. The dWf is change in weight fraction, dLogM is also referred to as dLog(MW) and is change in logarithm of molecular weight, and LogM is also referred to as Log(MW) and is logarithm of molecular weight.

The composition distribution of bimodal polyethylene refers to the distribution of comonomer, which form short chain branches, among the molecules that comprise the bimodal polyethylene. he composition distribution of bimodal polyethylene may be readily measured by methods known in the art, for example, Temperature Raising Elution Fractionation (TREF) or Crystallization Analysis Fractionation (CRYSTAF).

A greater amount of short chain branches for a bimodal polyethylene, as compared to another bimodal polyethylene, indicates that the bimodal polyethylene having the greater amount of short chain branches has a greater distribution of comonomer.

FIG. 2 includes trendline 257 corresponding to the bimodal polyethylene made by Example 1, trendline 259 corresponding to the bimodal polyethylene made by Example 2, and trendline 261 corresponding to the bimodal polyethylene made by Comparative Example A. Each of the trendlines is fit to respective data points corresponding to short chain branching values for Example 1, Example 2, and Comparative Example A.

As shown in FIG. 2, for the high molecular weight portion 253 both trendline 257 corresponding to the bimodal polyethylene made by Example 1 and trendline 259 corresponding to the bimodal polyethylene made by Example 2 are greater than trendline 261 corresponding to the bimodal polyethylene made by Comparative Example A. As such, the methods including a plurality of cycles of ratio adjustments, i.e., Example 1 and Example 2, provide an improved, e.g., increased, distribution of comonomer across the high molecular weight portion 253 of a bimodal distribution including the high molecular weight portion 253 and a low molecular weight portion 251.

1. A method of making a bimodal polyethylene, the method comprising:
feeding a bimodal catalyst system and a trim solution to a single reactor to establish an average steady-state trim/catalyst ratio, wherein the reactor has an average steady-state reactor residence time;
feeding ethylene and 1-hexene to the reactor to establish an average steady-state 1-hexene/ethylene ratio; and
performing a plurality of cycles of ratio adjustment, wherein each cycle of ratio adjustment comprises:
increasing the average steady-state trim/catalyst ratio to a relative maximum trim/catalyst ratio over a time interval that is from 5% to 15% of the average steady-state reactor residence time, while concurrently decreasing the average steady-state 1-hexene/ethylene ratio to a relative minimum 1-hexene/ethylene ratio;
decreasing the relative maximum trim/catalyst ratio to a relative minimum trim/catalyst ratio over a time interval that is from 10% to 30% of the average steady-state reactor residence time, while concurrently increasing the relative minimum 1-hexene/ethylene ratio to a relative maximum 1-hexene/ethylene ratio; and
increasing the relative minimum trim/catalyst ratio to the average steady-state trim/catalyst ratio over a time interval that is from 5% to 15% of the average steady-state reactor residence time, while concurrently decreasing the relative maximum 1-hexene/ethylene ratio to the average steady-state1-hexene/ethylene ratio.

2. The method of claim 1, wherein the plurality of cycles of ratio adjustment includes 10 to 100 cycles of ratio adjustment.

3. The method of claim 1, wherein the bimodal catalyst system includes a low molecular weight component and a high molecular weight component, and the trim solution includes the low molecular weight component.

4. The method of claim 1, wherein the relative maximum trim/catalyst ratio is 105% to 300% of the average steady-state trim/catalyst ratio on a molar basis.

5. The method of claim 1, wherein the relative minimum trim/catalyst ratio is 20% to 95% of the average steady-state trim/catalyst ratio on a molar basis.

6. The method of claim 1, wherein the relative maximum 1-hexene/ethylene is 110% to 250% of the average steady-state 1-hexene/ethylene on a molar basis.

7. The method of claim 1, wherein the relative minimum 1-hexene/ethylene is 35% to 90% of the average steady-state 1-hexene/ethylene ratio on a molar basis.
